(19) United States
(12) Patent Application Publication
(10) Pub. No.: US 2011/0177704 A1
(43) Pub. Date: Jul. 21, 2011

(54) INDOOR/OUTDOOR CABLE HARNESS SYSTEM

(76) Inventor: Siu Hung Felix Guinness Siu, Hong Kong (HK)

(21) Appl. No.: 12/987,047

(22) Filed: Jan. 7, 2011

Related U.S. Application Data
(60) Provisional application No. 61/296,146, filed on Jan. 19, 2010.

(51) Int. Cl. H01R 13/443

(52) U.S. Cl. 439/136

(57) ABSTRACT

A cable harness system having: a first distal portion having a power socket; a second distal portion having a power plug, the second distal portion being connected to the first distal portion; a power outlet located between the first and second distal portions and interconnected to the power cord. The power outlet having a power socket; an integrated cap having protruding pins which insert into corresponding pin holes of the power socket to prevent water from entering the pin holes of the at least one power socket, the cap releasably covering the power socket by inserting the protruding pins into the power socket when the power socket is not in use, and the cap releasably covering an earth pin hole of the power socket by inserting one protruding pin into an unused pin hole of the power socket when a two pin power plug is inserted into the power socket.

This nonprovisional application claims priority to U.S. Provisional Application No. 61/296,146, which was filed on September Jan. 19, 2010, and which is herein incorporated by reference.

### BACKGROUND OF THE INVENTION

1. Field of the Invention

The invention relates to a cable harness system for supplying electrical power in an indoor/outdoor environment.

2. Description of the Background Art

A harness, no matter it is for indoor or outdoor use, needs to be durable and safe. If water contacts any electrical component, it may cause a short circuit and be dangerous. Any repair required to remedy such electrical malfunction may be costly. Other negative consequences include consequential loss for the stakeholders involved in the decorations such as time cost, loss of trust, loss of future business, loss of visitor traffic during critical time in festive season. Also, when providing power for decorations, installation workers need to be able to work quickly and safely.

Therefore, there is a desire for a cable harness system that ensures safe and reliable electrical power connection and enables installation workers to work quickly and efficiently.

### SUMMARY OF THE INVENTION

In a first preferred aspect, there is provided a cable harness system for supplying electrical power in an indoor/outdoor environment, the system comprising: a first distal end portion having a power socket; a second distal end portion having a power plug, the second distal end portion being connected to the first distal end portion via a power cord; at least one power outlet located between the first and second distal end portions and interconnected to the power cord; wherein the power outlet includes: at least one power socket; an integrated cap having protruding pins which insert into corresponding pin holes of the at least one power socket to prevent water from entering the pin holes of the at least one power socket, the cap releasably covering the at least one power socket by inserting the protruding pins into the at least one power socket when the at least one power socket is not in use, and the cap releasably covering an earth pin of the at least one power socket by inserting one protruding pin into an unused pin hole of the at least one power socket when a two pin power plug is inserted into the at least one power socket.

The system may further comprise a hook integrated with the power outlet to hold an excess length of the power cord.

The system may further comprise at least one ring integrated with the power outlet to receiving a flying cable through the hole.

There may be two integrated rings, each ring positioned adjacent to the at least one power socket of the power outlet.

The system may have two or three power outlets located at various positions along the power cord.

The integrated cap may have three protruding pins.

The at least one power outlet may have two power sockets with two integrated caps.

The two power sockets may be disposed on the at least one power outlet on opposite sides of each other.

The power socket and power plug may each have a water resistant edge portion, the water resistant edge portion for the power plug resiliently deforming against the water resistant edge portion of the power socket when the power plug is connected to the power socket for providing water resistance.

The integrated cap may be operatively attached to the power outlet using a spring open hinge.

The system may further comprise a hanging ring defined on a surface of the power outlet.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective view of a harness according to an embodiment of the present invention;

FIG. 2 is a perspective view of the harness of FIG. 1 with a cap covering a power socket of a power outlet;

FIG. 3 is a perspective view of the harness of FIG. 1 with a two pin power plug inserted into the power socket of the power outlet;

FIG. 4 is a perspective view of the harness of FIG. 3 with a pin of the cap inserted into the earth pin of the power socket of the power outlet;

FIG. 5 is a perspective view of the harness of FIG. 1 without an integrated hook;

FIG. 6 is a perspective view of the power outlet depicted in FIG. 1 with an integrated hook;

FIG. 7 is a perspective view of the power outlet of FIG. 6 with an excess portion of the power cord held within the integrated hook;

FIG. 8 is a perspective view of the harness of FIG. 1 with an integrated ring;

FIG. 9 is a top view of the power outlet of FIG. 8 showing two integrated rings;

FIG. 10 is a perspective view of a harness with three interconnected power outlets;

FIG. 11 is a perspective view of a harness with two interconnected power outlets;

FIG. 12 is a perspective view of a harness with one interconnected power outlet;

FIG. 13 is a perspective view of water resistant edge portions for the power plug and power socket of the harness of FIG. 1, in a separated position;

FIG. 14 is a perspective view of the water resistant edge portions of FIG. 13 when the power plug and power socket are connected;

FIG. 15 is a perspective view of a harness according to another embodiment with an integrated cap in the closed position;

FIG. 16 is a perspective view of the harness of FIG. 15 with the integrated cap in the open position;

FIG. 17 is a perspective view of a harness of a further embodiment with a hanging ring; and

FIG. 18 is a perspective view of a harness of FIG. 17 oriented in a horizontal position.

### DETAILED DESCRIPTION OF THE DRAWINGS

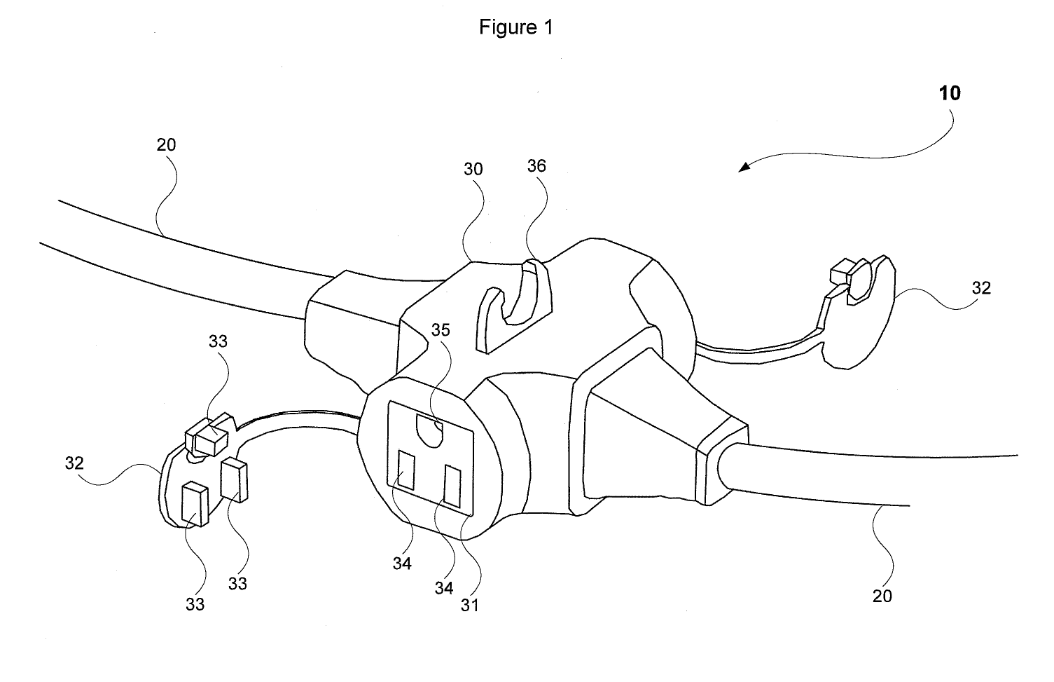

Referring to FIG. 1, a cable harness system 10 for supplying electrical power in an indoor/outdoor environment is provided. The harness 10 includes a power plug 11 and power socket 12 at its distal ends which are connected by a power cord 20. At least one power outlet 30 is interconnected to the power cord 20 between the distal ends of the harness 10. The power outlet 30 includes at least one power socket 31 and corresponding integrated cap 32. The cap 32 has protruding pins 33 which insert into the corresponding pins holes 34, 35 of the power socket 31 to prevent water from entering the pin holes 34, 35 of the power socket 31.

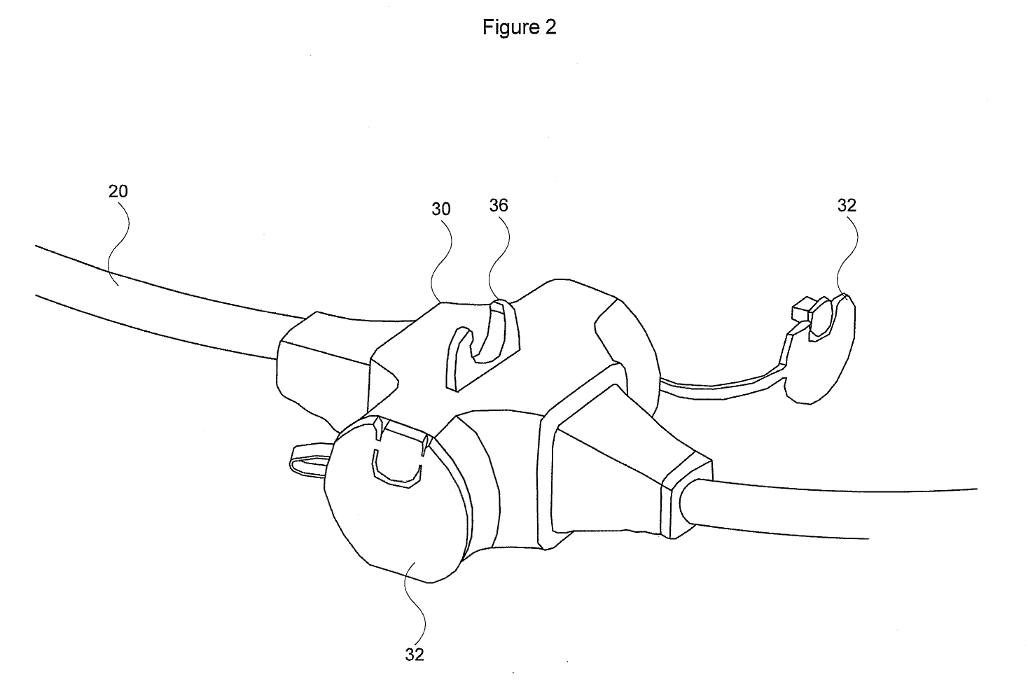

FIG. 2 shows that the cap 32 releasably covers the power socket 31 by inserting the protruding pins 33 into the power socket 31 when the power socket 31 is not in use.

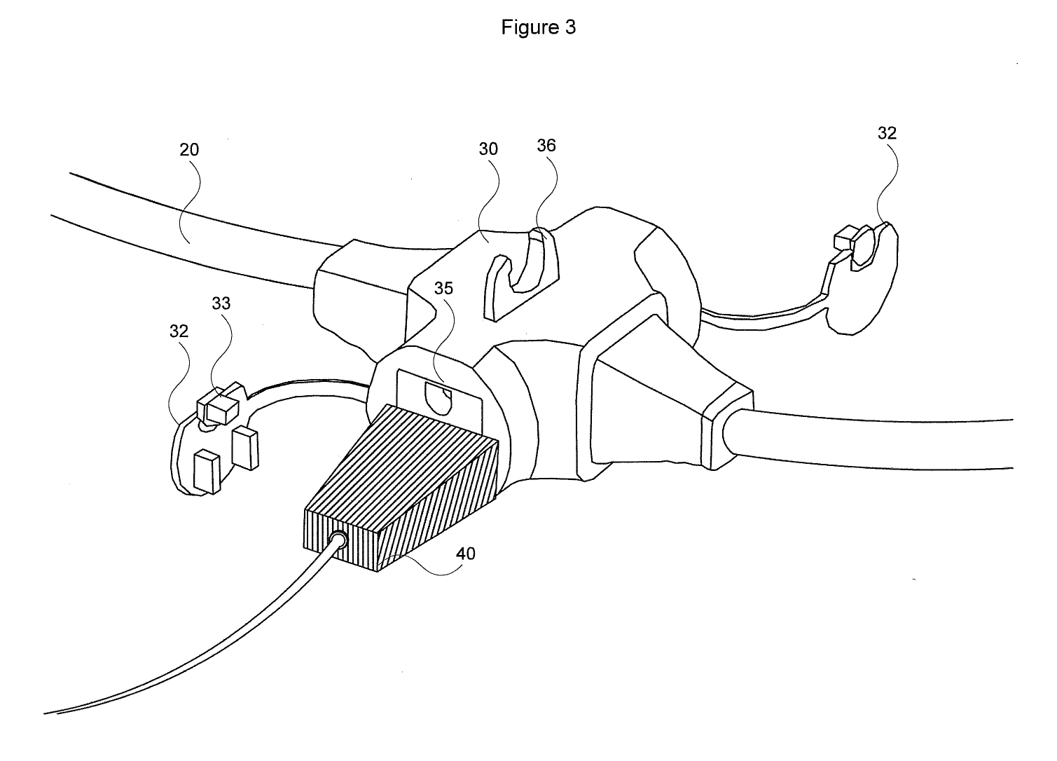

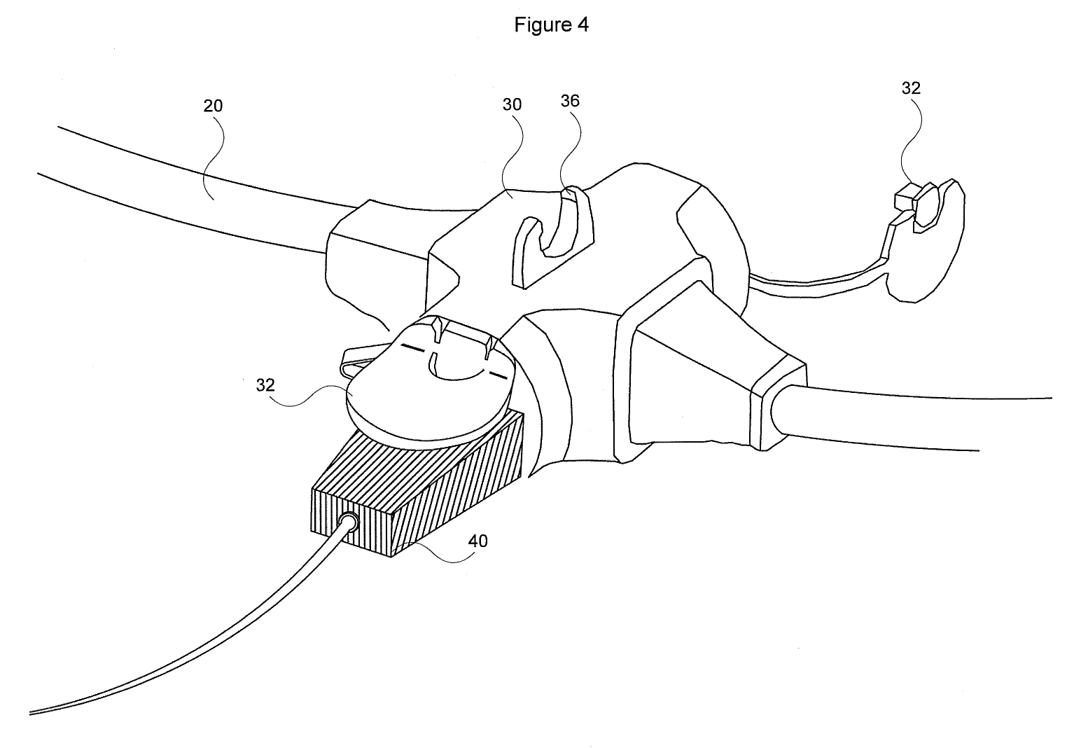

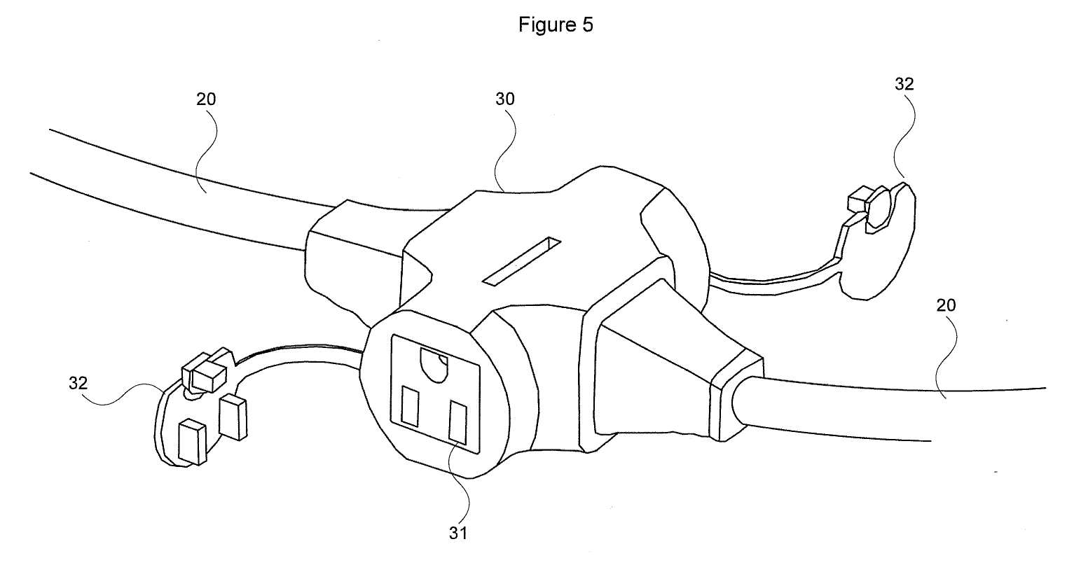

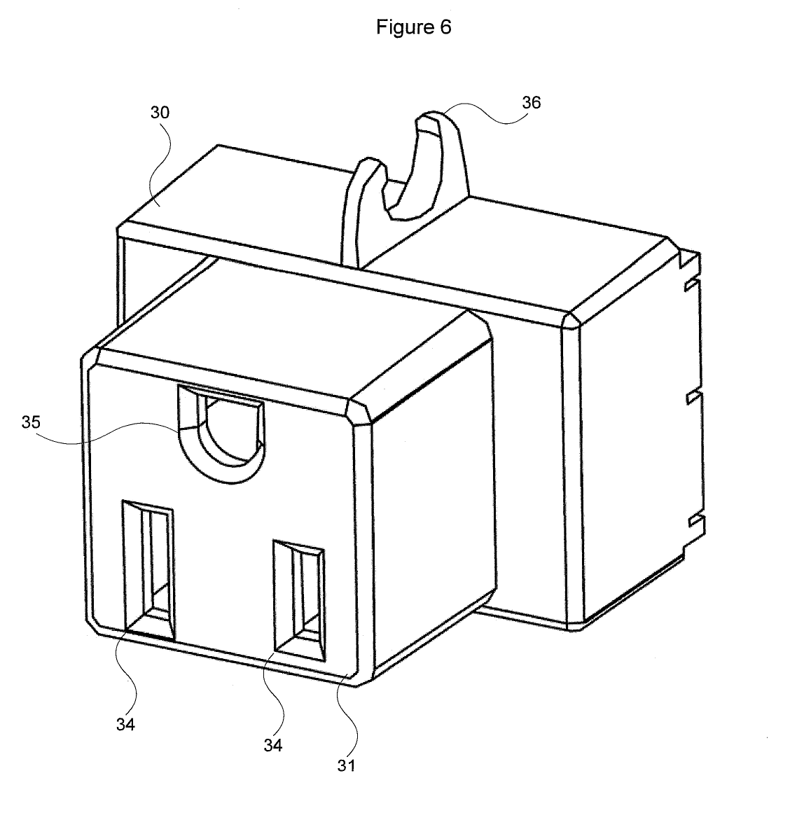

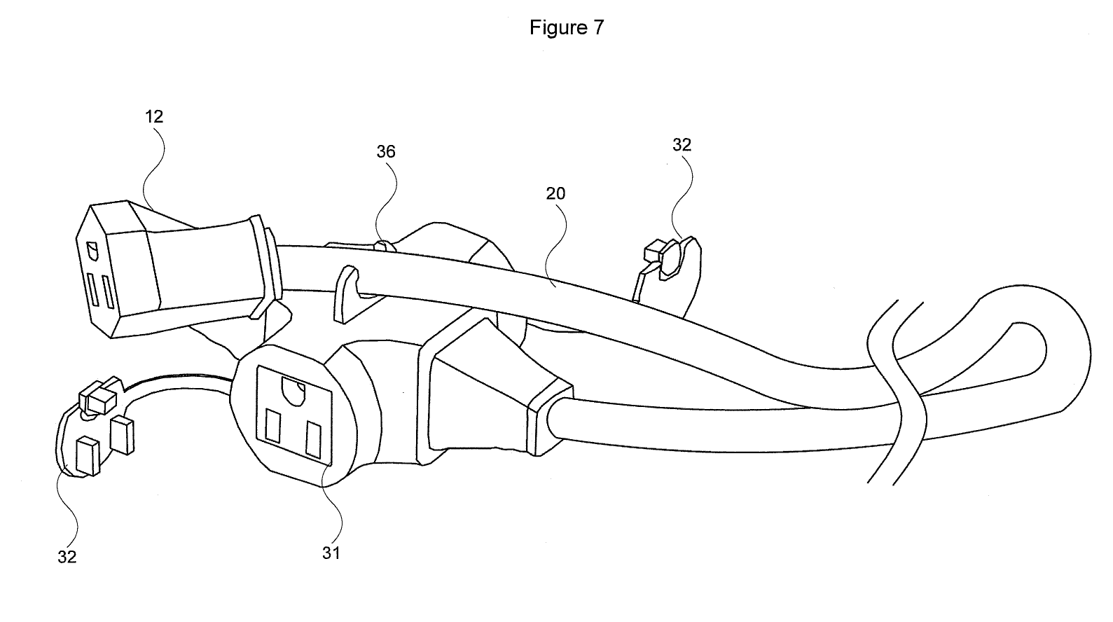

FIG. 3 shows a two pin power plug 40 initially inserted into the power socket 31. An earth pin hole 35 of the power socket 31 is initially exposed as it is unused by the two pin power plug 40. FIG. 4 shows the cap 32 releasably covering the earth pin hole 35 of the power socket 31. One protruding pin 33 of the cap 32 is inserted into the earth pin hole 35 of the power socket 31 after the two pin power plug 40 is inserted into the power socket 31. This prevents water from entering the earth pin hole 35 of the power socket 31. This prevents short circuit, for example, in the event of rain.

Preferably, the integrated cap 32 has three protruding pins 33. Preferably, the power outlet 30 has two power sockets 31 with two integrated caps 32. The two power sockets 31 are disposed on the power outlet 30 on opposite sides of each other.

Referring back to FIG. 2, a hook 36 integrated with the power outlet 30 is provided. The hook 36 holds an excess length of the power cord 20 during use. In one example, the hook 36 is made from a hard material which is less deformable than the material of the power cord 20. When a portion of the power cord 20 is held within tips of the hook 36, it is the material of the power cord 20 that may deform slightly against the hook 36 to secure the portion of the power cord 20 to the hook 36. The material for the hook 36 may be a non-conductible and high density outdoor plastic material which makes it durable and capable to hold any excess length of the power cord 20. This is useful when there is an excess length of power cord 20 that is to be secured so that it does not dangle down or become entangled with other objects or cables.

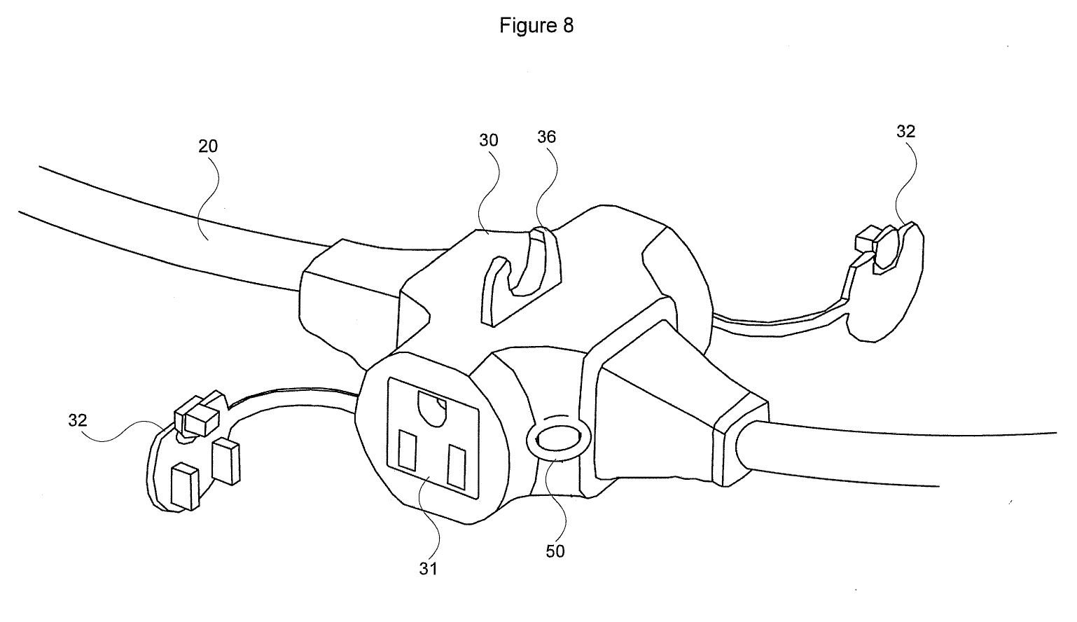

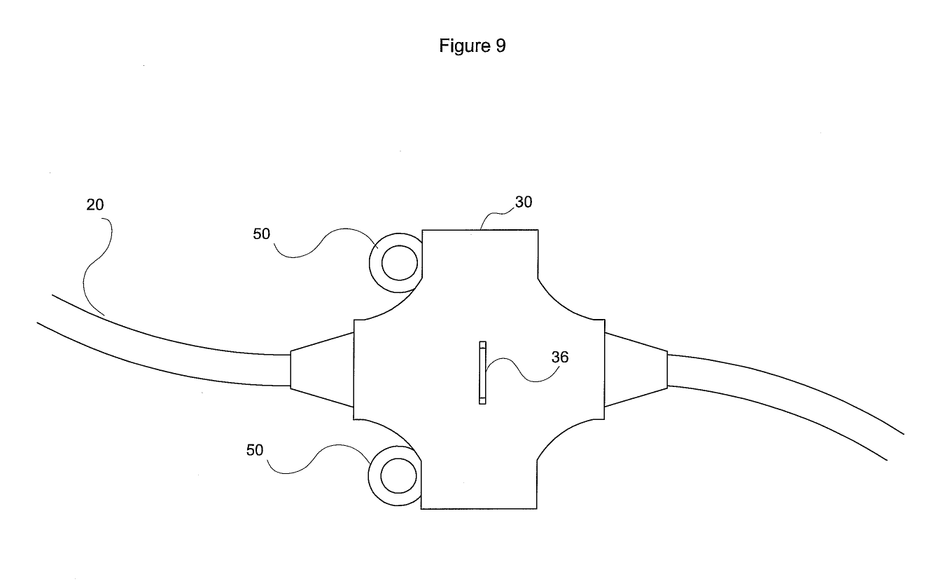

Referring to FIG. 8, at least one ring 50 integrated with the power outlet is provided. The ring 50 receives a flying cable through the hole of the ring 50. When the harness 10 is in a hanging position, a fixing device is required to stabilise the harness. The media of the fixing device may be a pull tie or flying cable so long as it suitable and has a size that can pass through the ring 50. Preferably as depicted in FIG. 9, there are two integrated rings 50. Each ring 50 is positioned adjacent to the power socket 31 of the power outlet 30.

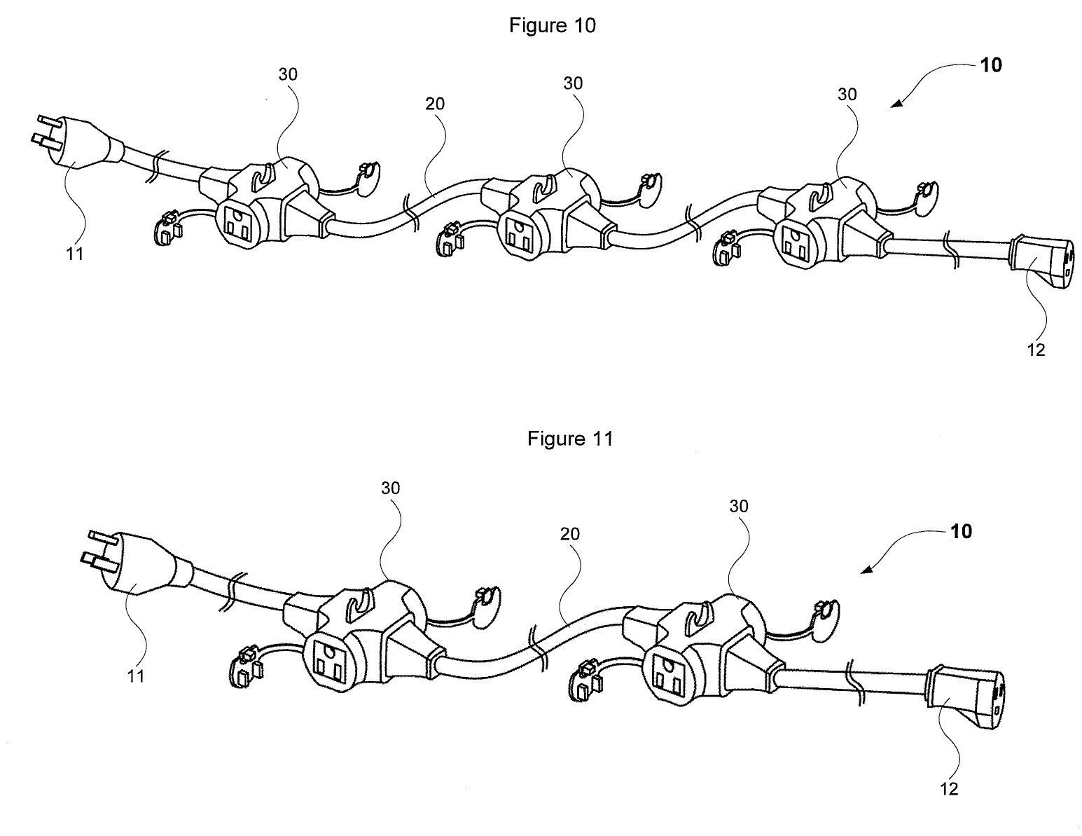

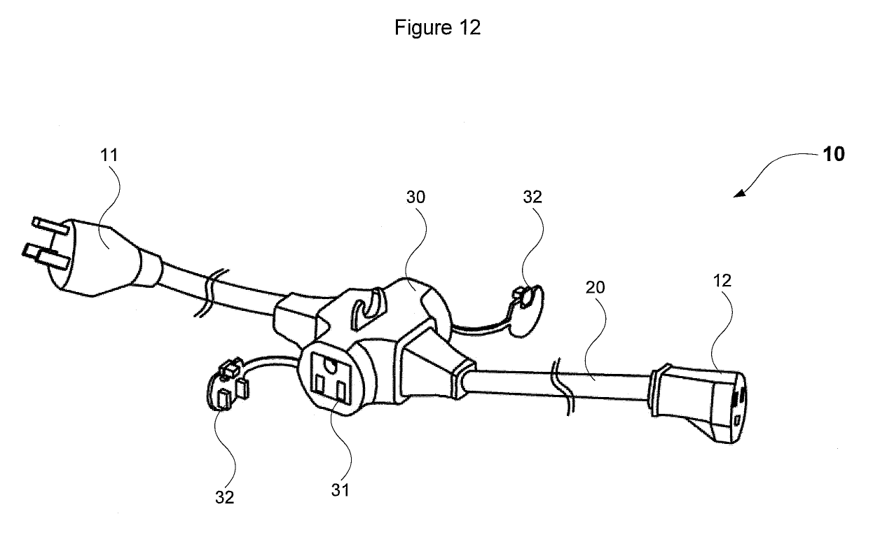

Referring to FIGS. 10 to 12, in some embodiments, the harness 10 has one to three power outlets 30 located at various positions along the power cord 20.

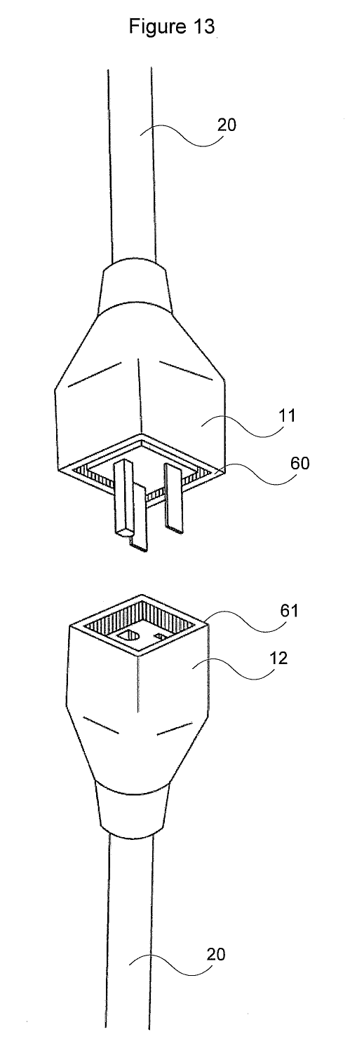

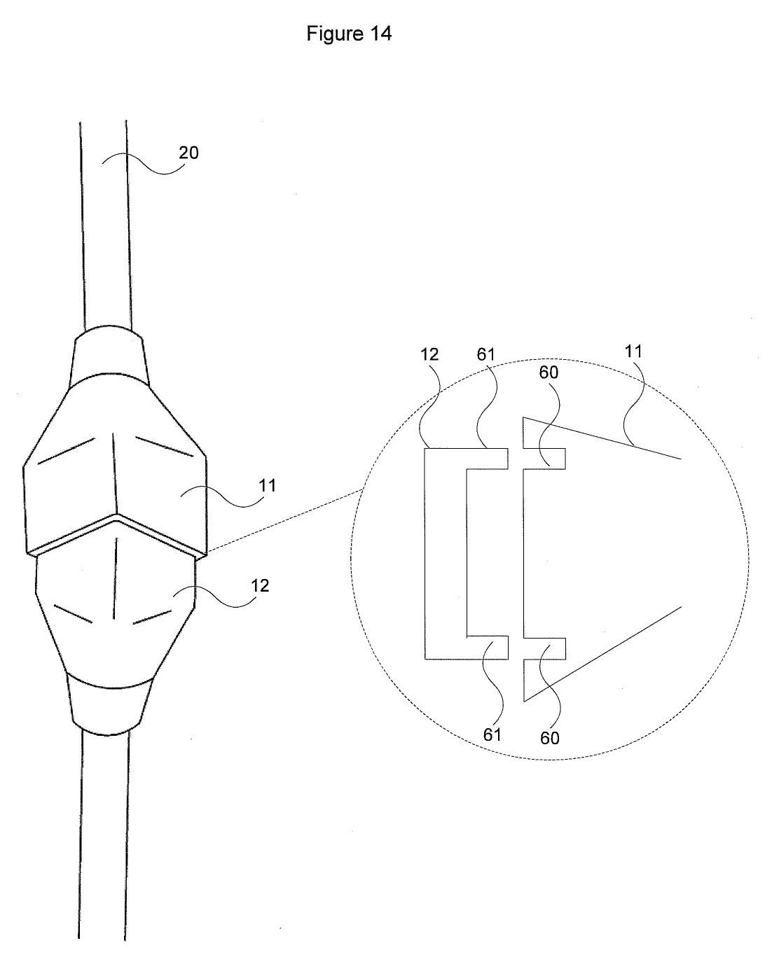

Referring to FIGS. 13 and 14, water resistant edge portions are depicted for the power plug 11 and power socket 12 of the harness 10. The water resistant edge portion for the power plug 11 has a groove 60 to receive a raised peripheral edge 61 of the power socket 12 of the harness 10. The edges 61 and grooves 60 of the water resistant edge portions are resiliently deformable to provide a water-resistant seal when the power plug 11 and power socket 12 are connected.

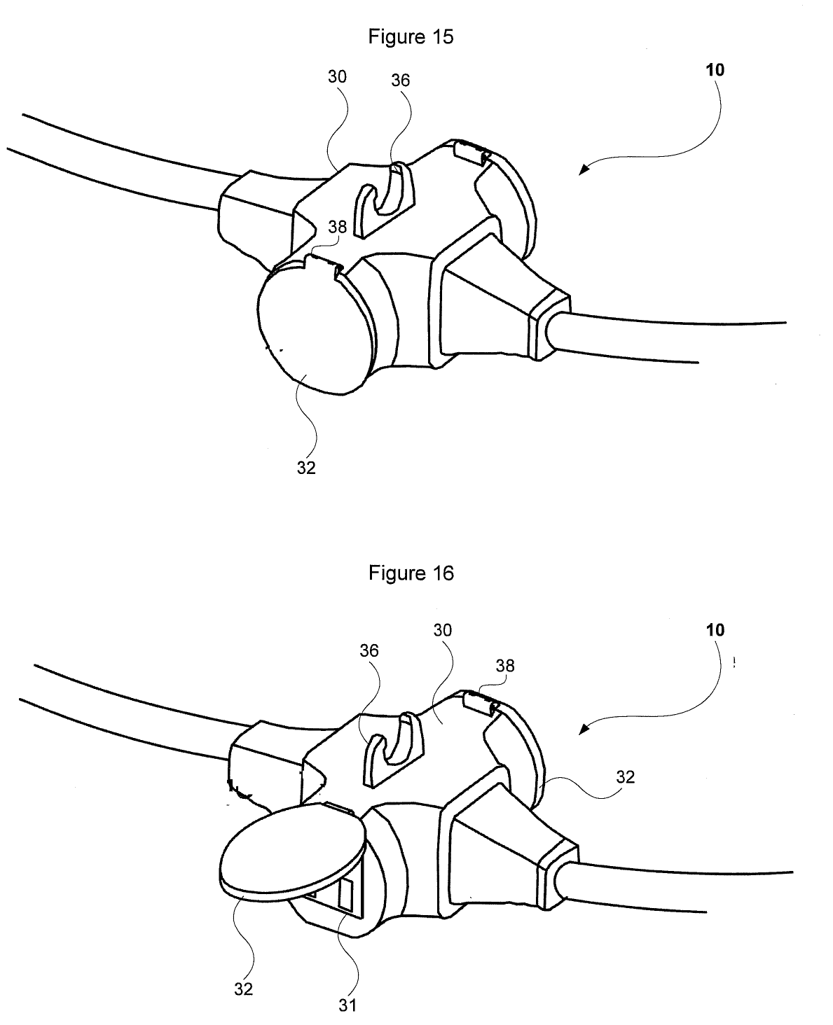

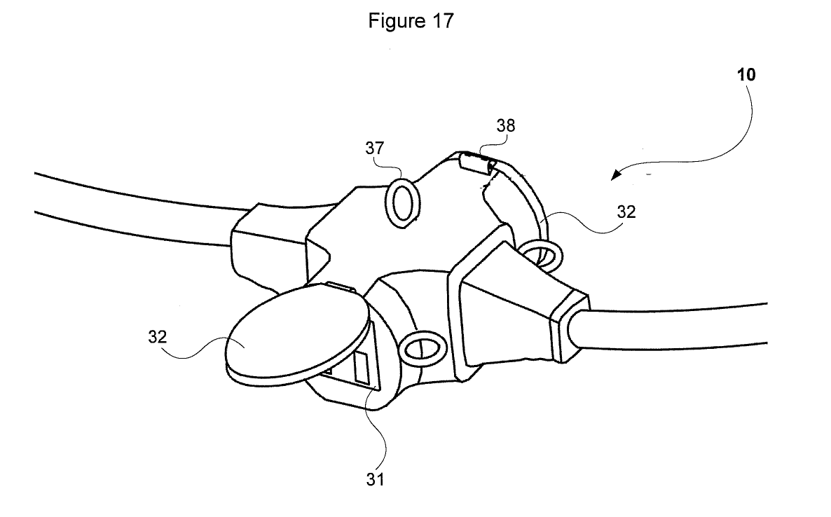

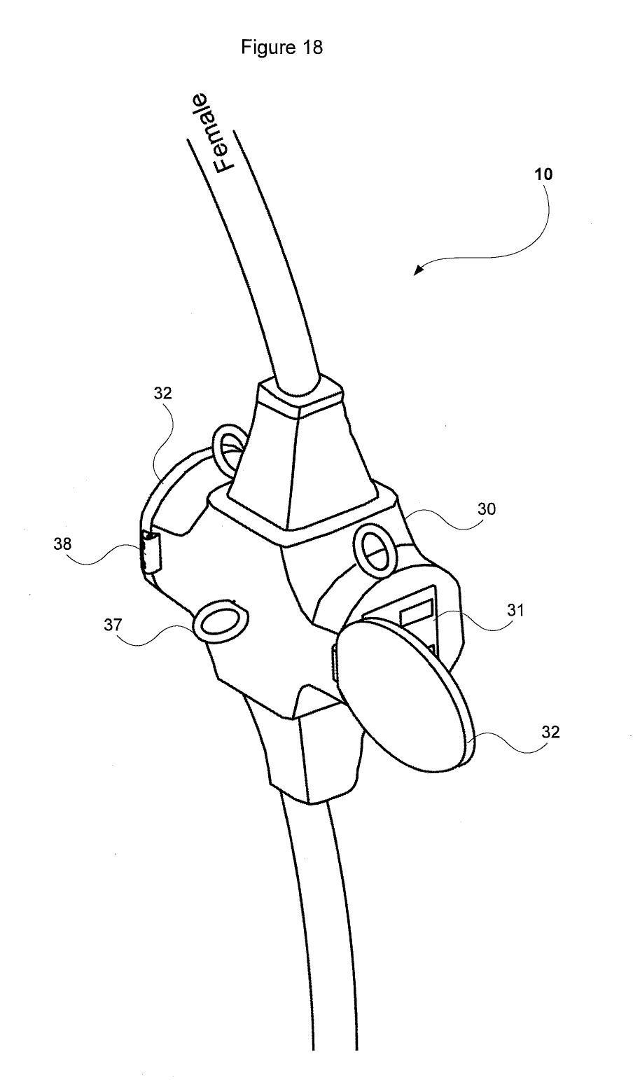

Referring to FIGS. 15 to 18, another cap 32 for the outlet 30 may be used. The cap 32 is operatively attached to the outlet 30 using a spring open hinge 38 to enhance water resistance. When the outlet 30 is not in use, the cap 32 can be closed for safety purposes. Also, there is a hanging ring 37 for the outlet 30. The ring 37 is added to the surface of the outlet 30 to provide one more hanging point for the harness 10. The harness 10 can therefore be hung horizontally.

The harness 10 is a handy device to make it quicker for installation workers to provide power to indoor/outdoor decorations, for example, install lighting on Christmas trees. The harness 10 enables re-use because it is durable. It is also suitable for various sizes of Christmas trees because more or less lighting can be attached to harness having one or more power outlets 30. The harness 10 also increases safety by providing water-resistance, ensuring electrical components do not short circuit due to water contact.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

What is claimed is:

1. An indoor/outdoor cable harness system for supplying electrical power, the system comprising:
a first distal end portion having a power socket;
a second distal end portion having a power plug, the second distal end portion being connectable to the first distal end portion via a power cord; and
at least one power outlet arranged between the first and second distal end portions and interconnected to the power cord, the power outlet comprising:
at least one power socket; and
an integrated cap having protruding pins which insert into corresponding pin holes of the at least one power socket to prevent water from entering the pin holes of the at least one power socket, the cap releasably covering the at least one power socket by inserting the protruding pins into the at least one power socket when the at least one power socket is not in use, and the cap releasably covering an earth pin of the at least one power socket by inserting one protruding pin into an unused pin hole of the at least one power socket when a two pin power plug is inserted into the at least one power socket.

2. The system according to claim 1, further comprising a hook integrated with the power outlet to carry an excess length of the power cord.

3. The system according to claim 1, further comprising at least one ring integrated with the power outlet to receiving a flying cable through the hole.

4. The system according to claim 1, wherein there are two integrated rings, each ring positioned adjacent to the at least one power socket of the power outlet.

5. The system according to claim 1, wherein the harness has two or three power outlets located at various positions along the power cord.

6. The system according to claim 1, wherein the integrated cap has three protruding pins.

7. The system according to claim 1, wherein the at least one power outlet has two power sockets with two integrated caps.

8. The system according to claim 7, wherein the two power sockets are disposed on the at least one power outlet on opposite sides of each other.

9. The system according to claim 1, wherein the power socket and power plug each have a water resistant edge portion, the water resistant edge portion for the power plug resiliently deforming against the water resistant edge portion of the power socket when the power plug is connected to the power socket for providing water resistance.

10. The system according to claim 1, wherein the integrated cap is operatively attached to the power outlet using a spring open hinge.

11. The system according to claim 1, further comprising a hanging ring defined on a surface of the power outlet.
